(19) United States
(12) Patent Application Publication
(10) Pub. No.: US 2025/0237543 A1
(43) Pub. Date: Jul. 24, 2025

(54) Passive Long Range Acoustic Sensing System Using Nonlinear Tags

(71) Applicant: Northeastern University, Boston, MA (US)

(72) Inventors: Cristian Cassella, Boston, MA (US); Hussein M.E. Hussein, Boston, MA (US); Pietro Simeoni, Boston, MA (US); Luca Colombo, Boston, MA (US); Omer Mohamed Osman Abdalla, Milano (IT); Matteo Rinaldi, Boston, MA (US)

(21) Appl. No.: 19/032,954

(22) Filed: Jan. 21, 2025

Related U.S. Application Data
(60) Provisional application No. 63/623,199, filed on Jan. 19, 2024.

(51) Int. Cl. G01H 11/08; H01Q 1/22; H04R 17/02

(52) U.S. Cl. CPC G01H 11/08; H01Q 1/2225; H04R 17/02

(57) ABSTRACT

Provided herein are systems for a wireless, battery-free acoustic sensor having a subharmonic tag (SubHT) and an acoustic transducer, wherein the acoustic transducer is integrated with the SubHT, such that an acoustic signal received by the acoustic transducer modulates an electrical output of the SubHT when the SubHT is interrogated by a radiofrequency input signal of a reader device, resulting in conversion of the acoustic signal into information transmitted by the sensor via a radiofrequency output signal without the use of battery power.

### CROSS REFERENCE TO RELATED APPLICATIONS

This application claims benefit under 35 U.S.C. § 119(e) of U.S. Provisional Application No. 63/623,199, filed on 19 Jan. 2024, entitled “Passive Long Range Acoustic Sensing System Using Nonlinear Tags” the entirety of which is incorporated by reference herein.

### STATEMENT REGARDING FEDERALLY SPONSORED RESEARCH OR DEVELOPMENT

This invention was made with government support under Grant Nos. 1854573 and 1726512 awarded by the National Science Foundation. The government has certain rights in the invention.

### BACKGROUND

Recent advancements in piezoelectric thin-film machining have led to the creation of highly sensitive micro-ultrasonic sensors such as pMUTs. These transducers have been envisioned as integral components in expansive Wireless Sensor Networks (WSNs) designed for the meticulous monitoring of critical environmental and structural parameters. However, these sensor networks have been stymied by persistent energy constraints, predominantly related to the need for periodic battery replacement—a logistical complication that undermines large-scale deployment and necessitates frequent maintenance. Prior attempts to address this challenge have not sufficiently eliminated the reliance on active power sources.

Due in part to these challenges, there is a growing recognition of the importance of passive nodal systems within the expansive realm of the Internet of Things (IoT). Such passive nodal systems, which incorporate acoustic and radiofrequency (RF) sensor nodes, are set to bring in a new era of unprecedented innovation and limitless connectivity possibilities. The aspirational goal of such nodes is to integrate the digital and physical realms, unrestricted from the conventional constraints of traditional power sources, thereby overcoming the usual limitations associated with energy dependency. However, although such passive acoustic and RF sensors possess immense potential, their current capabilities and implementation are still in the early stages.

There is a diverse range of applications for acoustic and ultrasonic sensing which extends across all industries, demonstrating a profound influence on both industry and society. For example, acoustic sensing within the audible spectrum is remarkably versatile, ranging from monitoring patient sounds like coughing or breathing for medical diagnosis using Piezoelectric Acoustic Sensor-based sound recognition systems [1], to the evaluation of noise pollution in both urban and natural settings [2]. In the realm of ultrasonics, advanced sensors are pivotal in healthcare, enabling sophisticated diagnostic imaging and innovative treatment methodologies [3]. These ultrasonic sensors are integral to the progression of precision medicine, providing the means for more accurate and less invasive targeted medical interventions. Additionally, in the industrial sector, ultrasonic sensing plays a crucial role in quality control through non-destructive testing and material characterization [4]. The incorporation of ultrasonic technology, which enables user interface control and touch-free gesture detection in smart gadgets, has also had an impact on consumer electronics [5]. Many such applications have been achieved using a range of acoustic sensing technologies, which include traditional bulk transducers as well as advanced micro-and nanoscale sensor arrays. Piezoelectric sensors, which were formerly characterized by their unwieldy dimensions, have now undergone a transformation resulting in diminished form factors and enhanced operational efficacy.

The utilization of MEMS technology has facilitated the development of minuscule, yet highly efficient, sensors at the microscale level. In particular, the emergence of Piezoelectric Micromachined Ultrasonic Transducers (pMUTs) represents a significant turning point in the diverse field of ultrasonic technology. Synthesizing the newest developments in micromachining techniques with the forefront of piezoelectric materials advancement, these transducers embody a significant leap in precision and efficacy, making them suitable for a broad spectrum of applications in ultrasonic-based systems [6]. The adaptable nature and wide-ranging applicability of pMUTs are evident through their utilization in diverse domains such as intrabody communication, wireless power transfer methods, and the continually expanding field of Internet of Things (IoT) applications [7]. Furthermore, ongoing research into nanotechnology could push the limits even further, which could have a huge effect on sensory networks by using nano-acoustic devices.

Additionally, over the last few years, attention has been paid to the development of linear-time-variant (LTV) circuits and systems implementing unique RF functionalities. For instance, several RF circulators, filters and isolators have been developed, based on the unique dynamics triggered by the periodic modulation or switching of solid-state capacitors. Recently, a new class of passive, chip-less and battery-less wireless sensors, dubbed Subharmonic Tags (SubHTs) have been developed, which permit passive sensing of parameters of interest with boosted sensitivity and dynamic range. However, while prior SubHT prototypes have shown promise in providing sensing performance not achievable through conventional linear-time-invariant (LTI) counterparts, such prototypes have not been able to provide the required identification functionality to enable their use in massive and heterogeneous sensing infrastructures.

### SUMMARY

The present technology provides a battery-free acoustic sensor system designed to integrate nonlinear tags having time-modulated circuitry (e.g., SubHTs) with any acoustic sensor that can produce current within a desired range, enabling truly passive wireless sensing capabilities. As proof of concept of the proposed system, the SubHTs were integrated with a Piezo-based ultrasonic sensor, more specifically an array of pMUTs. This advancement not only boosts the possibilities of passive nodal systems within the Internet of Things (IoT), but also improves their integration into everyday life, representing a notable progression towards a connected and intelligent world.

In one aspect, a wireless, battery-free acoustic sensor is provided. The sensor includes a subharmonic tag (SubHT). The sensor also includes an acoustic transducer. The sensor also includes wherein the acoustic transducer is integrated with the SubHT, such that an acoustic signal received by the acoustic transducer modulates an electrical output of the SubHT when the SubHT is interrogated by a radiofrequency input signal of a reader device, resulting in conversion of the acoustic signal into information transmitted by the sensor via a radiofrequency output signal without the use of battery power.

In some embodiments, the acoustic transducer is capable of receiving an acoustic signal and transmitting an electromagnetic signal comprising information from the acoustic signal. In some embodiments, the acoustic signal has a frequency in an audible range of 20 Hz to 20 KHz. In some embodiments, the acoustic transducer is a piezoelectric microphone. In some embodiments, the acoustic signal is an ultrasonic signal having a frequency greater than 20 kHz. In some embodiments, the acoustic transducer includes at least one piezoelectric micromachined ultrasonic transducer (pMUT) element, at least one piezoelectric nanoscale ultrasonic transducer (pNUT) element, at least one capacitive micromachined ultrasonic transducer (cMUT) element, at least one bulk-piezo transducer element, or combinations thereof. In some embodiments, the acoustic transducer includes an array of pMUT elements, pNUT elements, cMUT elements, or combinations thereof. In some embodiments, the output signal is an amplitude modulated radiofrequency signal. In some embodiments, the sensor also includes a radiofrequency input antenna integrated with the SubHT and configured to receive the input signal from the reader device. In some embodiments, an input antenna for receiving the input signal from the reader device and the acoustic transducer are integrated with the SubHT via a power combiner configured to combine the electromagnetic input from the acoustic transducer with the input signal from the input antenna, and to transmit a combined signal to the SubHT. In some embodiments, the sensor includes a second acoustic transducer, wherein the acoustic signal is an ultrasonic signal. In some embodiments, the second acoustic transducer includes at least one piezoelectric micromachined ultrasonic transducer (pMUT) element and/or at least one capacitive micromachined ultrasonic transducer (cMUT) element.

In some embodiments, the acoustic transducer is monolithically integrated with the SubHT. In some embodiments, the acoustic transducer is hybridly integrated with the SubHT. In some embodiments, a frequency of the output signal is half of a frequency of the input signal. In some embodiments, the frequency of the input signal is an overtone of a fundamental resonant frequency of the SubHT. In some embodiments, a frequency of the output signal is half of a frequency of the input signal. In some embodiments, a frequency of the electromagnetic signal transmitted by the acoustic transducer is lower than the frequency of the output signal. In some embodiments, the electromagnetic signal transmitted by the acoustic transducer interacts with the SubHT to produce a spectrum of intermodulation products, each spaced from the frequency of the output signal according to the product of multiplying the frequency of the electromagnetic signal transmitted by the acoustic transducer by a corresponding intermodulation integer order.

In another aspect, an acoustic sensing system is provided. The system includes one or more wireless, battery-free acoustic sensors, each sensor including a subharmonic tag (SubHT) and an acoustic transducer. The system also includes a reader device configured for transmitting a radiofrequency input signal to the one or more acoustic sensors. The system also includes wherein the acoustic transducer of each sensor is integrated with the SubHT of that sensor such that an acoustic signal received by the acoustic transducer modulates an electrical output of the SubHT when the SubHT is interrogated by the radiofrequency input signal of the reader device, resulting in conversion of the acoustic signal into information transmitted by the sensor via a radiofrequency output signal without the use of battery power. The system also includes wherein the reader device is further configured for receiving the radiofrequency output signal transmitted in return by the one or more acoustic sensors.

In some embodiments, the system also includes one or more acoustic transceivers and/or transmitters capable of transmitting the acoustic signal to the sensor. In some embodiments, the reader is further configured to extract the acoustic signal received by the sensor, or information associated therewith, from the modulated radiofrequency output signal received by the reader device.

In another aspect, a method of monitoring acoustic signals in an environment is provided. The method includes providing the system of claim 16, wherein one or more sensors of the system are deployed in said environment. The method also includes transmitting the radiofrequency input signal to a sensor of the system using the reader device. The method also includes receiving the radiofrequency output signal from the sensor using the reader device. The method also includes whereby the radiofrequency output signal received by the reader device is modulated by an acoustic signal received by the sensor from the environment.

In some embodiments, the method also includes extracting the acoustic signal received by the sensor, or information associated therewith, from the modulated electromagnetic signal received by the reader device. In some embodiments, a distance between the sensor and the reader device is at least 10 meters. In some embodiments, the distance between the sensor and the reader device is at least 1000 meters. In some embodiments, the radiofrequency input signal is received either contemporaneously with the acoustic signal or non-contemporaneously with the acoustic signal.

Additional features and aspects of the technology include the following:
1. A wireless, battery-free acoustic sensor, comprising:
   a subharmonic tag (SubHT); and
   an acoustic transducer;
   wherein the acoustic transducer is integrated with the SubHT, such that an acoustic signal received by the acoustic transducer modulates an electrical output of the SubHT when the SubHT is interrogated by a radiofrequency input signal of a reader device, resulting in conversion of the acoustic signal into information transmitted by the sensor via a radiofrequency output signal without the use of battery power.
2. The sensor of feature 1, wherein the acoustic transducer is capable of receiving an acoustic signal and transmitting an electromagnetic signal comprising information from the acoustic signal.
3. The sensor of feature 2, wherein:
   the acoustic signal has a frequency in an audible range of 20 Hz to 20 kHz; and
   the acoustic transducer is a piezoelectric microphone.
4. The sensor of feature 2, wherein:
   the acoustic signal is an ultrasonic signal having a frequency greater than 20 kHz; and
   the acoustic transducer includes at least one piezoelectric micromachined ultrasonic transducer (pMUT) element, at least one piezoelectric nanoscale ultrasonic transducer (pNUT) element, at least one capacitive micromachined ultrasonic transducer (cMUT) element, at least one bulk-piezo transducer element, or combinations thereof.
5. The sensor of feature 4, wherein the acoustic transducer includes an array of pMUT elements, pNUT elements, cMUT elements, or combinations thereof.
6. The sensor of any of features 1-5, wherein the output signal is an amplitude modulated radiofrequency signal.
7. The sensor of any of features 1-6, further comprising a radiofrequency input antenna integrated with the SubHT and configured to receive the input signal from the reader device.
8. The sensor of any of features 2-7, wherein an input antenna for receiving the input signal from the reader device and the acoustic transducer are integrated with the SubHT via a power combiner configured to combine the electromagnetic input from the acoustic transducer with the input signal from the input antenna, and to transmit a combined signal to the SubHT.
9. The sensor of any of features 3-8, further comprising a second acoustic transducer, wherein:
   the acoustic signal is an ultrasonic signal; and
   the second acoustic transducer includes at least one piezoelectric micromachined ultrasonic transducer (pMUT) element and/or at least one capacitive micromachined ultrasonic transducer (cMUT) element.
10. The sensor of any of features 1-9, wherein the acoustic transducer is monolithically integrated with the SubHT.
11. The sensor of any of features 1-10, wherein the acoustic transducer is hybridly integrated with the SubHT.
12. The sensor of any of features 1-11, wherein a frequency of the output signal is half of a frequency of the input signal.
13. The sensor of any of features 1-12, wherein the frequency of the input signal is an overtone of a fundamental resonant frequency of the SubHT.
14. The sensor of any of features 2-13, wherein:
   a frequency of the output signal is half of a frequency of the input signal;
   a frequency of the electromagnetic signal transmitted by the acoustic transducer is lower than the frequency of the output signal; and
   the electromagnetic signal transmitted by the acoustic transducer interacts with the SubHT to produce a spectrum of intermodulation products, each spaced from the frequency of the output signal according to the product of multiplying the frequency of the electromagnetic signal transmitted by the acoustic transducer by a corresponding intermodulation integer order.
15. An acoustic sensing system comprising:
   one or more wireless, battery-free acoustic sensors, each sensor including a subharmonic tag (SubHT) and an acoustic transducer; and
   a reader device configured for transmitting a radiofrequency input signal to the one or more acoustic sensors,
   wherein the acoustic transducer of each sensor is integrated with the SubHT of that sensor such that an acoustic signal received by the acoustic transducer modulates an electrical output of the SubHT when the SubHT is interrogated by the radiofrequency input signal of the reader device, resulting in conversion of the acoustic signal into information transmitted by the sensor via a radiofrequency output signal without the use of battery power, and
   wherein the reader device is further configured for receiving the radiofrequency output signal transmitted in return by the one or more acoustic sensors.
16. The system of feature 15, further comprising one or more acoustic transceivers and/or transmitters capable of transmitting the acoustic signal to the sensor.
17. The system of any of features 15-16, wherein the reader is further configured to extract the acoustic signal received by the sensor, or information associated therewith, from the modulated radiofrequency output signal received by the reader device.
18. A method of monitoring acoustic signals in an environment, the method comprising the steps of:
   providing the system of claim 16, wherein one or more sensors of the system are deployed in said environment;
   transmitting the radiofrequency input signal to a sensor of the system using the reader device; and
   receiving the radiofrequency output signal from the sensor using the reader device;
   whereby the radiofrequency output signal received by the reader device is modulated by an acoustic signal received by the sensor from the environment.
19. The method of feature 18, further comprising:
   extracting the acoustic signal received by the sensor, or information associated therewith, from the modulated electromagnetic signal received by the reader device.
20. The method of any of features 18-19, wherein a distance between the sensor and the reader device is at least 10 meters.
21. The method of feature 20, wherein the distance between the sensor and the reader device is at least 1000 meters.
22. The method of any of features 18-21, wherein the radiofrequency input signal is received either contemporaneously with the acoustic signal or non-contemporaneously with the acoustic signal.

### BRIEF DESCRIPTION OF THE DRAWINGS

FIG. 1A illustrates a schematic showing an architecture of a battery-free acoustic sensor having an acoustic transducer integrated with non-linear tags for passive wireless acoustic sensing.

FIG. 1B illustrates a schematic of the battery-free acoustic sensor of FIG. 1A wherein the acoustic transducer is a piezoelectric micromachined ultrasonic transducer (pMUT) suitable for passive wireless sensing of ultrasonic wave and integrated with a non-linear tag “SubHT”.

FIG. 2 illustrates a fabricated prototype SubHT.

FIG. 3 illustrates a fabricated prototype 20×20 pMUT array for integration with the prototype SubHT of FIG. 2.

FIG. 4 illustrates a pMUT fabrication flow.

FIG. 5 illustrates measured pMUT displacement sensitivity.

FIG. 6 illustrates a digital holographic microscopy setup for measuring a pMUT's displacement.

FIG. 7 illustrates an experimental setup used to test a prototype battery-free acoustic sensor, including probing the SubHT with an RF signal generator. The RF response is captured using a spectrum analyzer, all while varying the transmitted ultrasonic pressure produced by an ultrasonic transmitter.

FIG. 8 illustrates a measured spectrum of the received signal transmitted from the SubHT when the detected acoustic pressure is 15 kPa.

FIG. 9 illustrates measured output power of the pMUT intermodulation signal versus the corresponding acoustic pressure detected.

FIG. 10 illustrates acoustic pressure at the pMUT, as measured by a hydrophone, versus the ultrasonic transmitter's input voltage.

FIG. 11 illustrates measured output power of the pMUT intermodulation signal when applying a chirp signal to the ultrasonic transmitter at a fixed acoustic pressure.

FIG. 12 illustrates a structural health monitoring system for ultrasound-based non-destructive testing techniques (NDT), wherein the system includes a network of battery-free acoustic sensors.

FIG. 13 illustrates an underwater communications and networking system, wherein the system includes one or more battery-free acoustic sensors (not shown) acting as wake-up receivers.

### DETAILED DESCRIPTION

Provided herein are systems and methods for battery-free acoustic sensors integrating nonlinear tags having time-modulated circuitry (e.g., SubHTs) with any acoustic sensor that can produce current within a desired range, enabling truly passive wireless sensing capabilities. As proof of concept of the proposed system, the SubHTs were integrated with a Piezo-based ultrasonic sensor, more specifically an array of pMUTs. This advancement not only boosts the possibilities of passive nodal systems within the Internet of Things (IoT), but also improves their integration into everyday life, representing a notable progression towards a connected and intelligent world.

Additionally, a framework is provided that enables a distributed network of acoustic transducer-based wireless sensor networks (WSNs), which are uniquely engineered for long- and short-range ultrasonic wave detection. The technology significantly reduces reliance on or eliminates the need for batteries in WSNs for acoustic sensing and significantly enhances the current capabilities of acoustic transducer-based WSNs, opening new exciting opportunities for such WSNs in a plethora of emerging Internet-of-Things (IoT) applications.

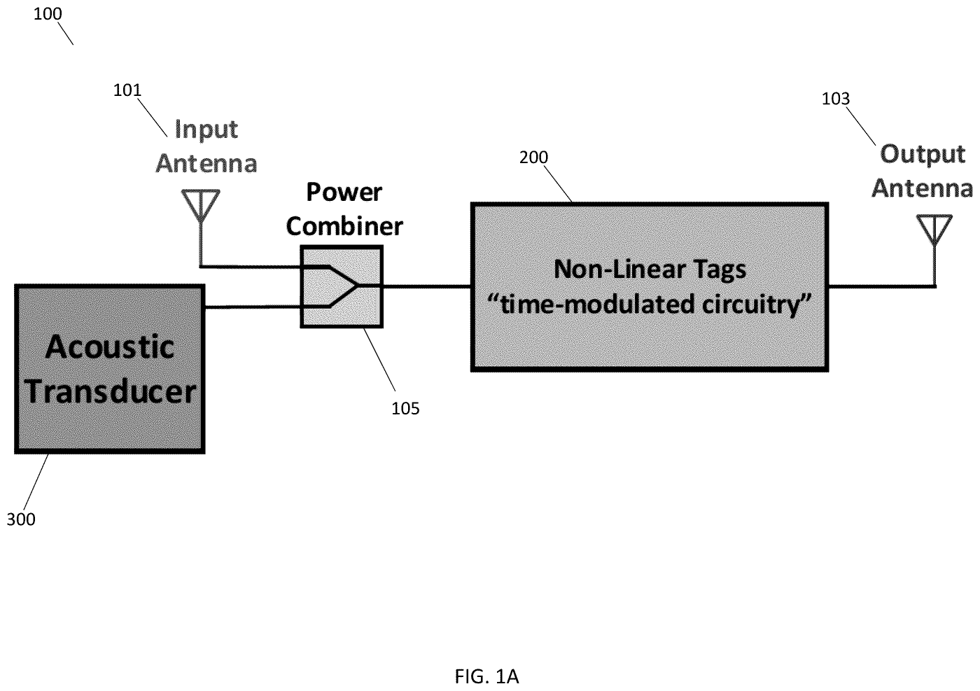

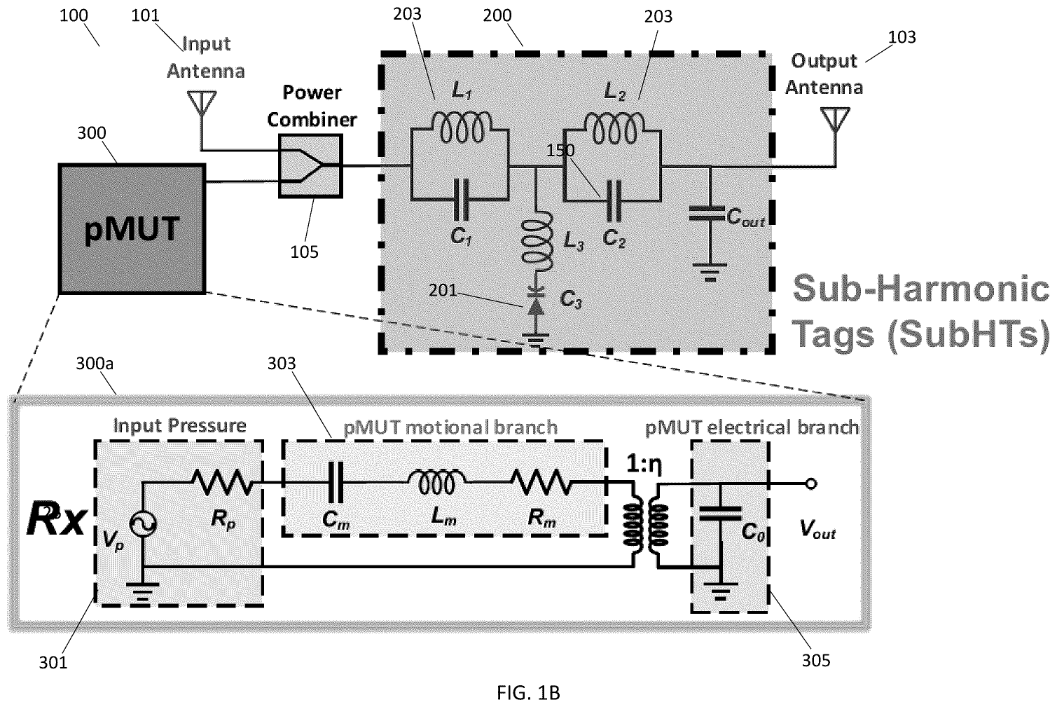

As such, the present technology provides a new category of passive long range acoustic sensors having radiofrequency (RF) transducer-based, non-linear tags. More specifically, referring now to FIGS. 1A-1B, battery-free acoustic sensors 100 are provided, each having an acoustic transducer 300 used as a transduction element, while non-linear tags having time-modulated circuitry 200 (e.g., subharmonic tags (SubHTs) 200 as shown in FIG. 1B) are adopted for analog signal processing and retrieval. As discussed in further detail below, the experimental prototype was engineered explicitly for far-field sensing applications at Ultra High Frequency (UHF). However, the technology can be readily scaled to lower and higher frequencies.

In this regard, the battery-free acoustic sensors 100 provided herein are engineered to function across a broad acoustic frequency spectrum, determined by the chosen transducer type. For instance, in the audible range from 20 Hz to 20 kHz, a piezo-microphone can be utilized, while for the ultrasonic spectrum—extending from 20 kHz to even higher frequencies—transducers such as piezoelectric micromachined ultrasonic transducers (pMUTs) or capacitive micromachined ultrasonic transducers (cMUTs) are suitable. Meanwhile the time-modulated non-linear tags in the node facilitate passive wireless communication, primarily operating at UHF, with the capability to adapt to both lower and higher frequency operations.

In use, the architecture of the sensor 100 is configured to incorporate the acoustic transducer 300, enabling the passive sensing of acoustic waves over extended distances and conversion thereof into corresponding electromagnetic waves. The sensor 100 converts and encodes the low-frequency motion of the acoustic transduction element 300 into the amplitudes of modulated electrical signals with a spectrum centered at half of the SubHT's 200 radiofrequency (RF) interrogation frequency (fᵢₙ). To achieve this, the sensor 100 employs a specialized set of lumped components, including the SubHT 200 having a non-linear impedance (e.g. by a varactor 201 as shown) in electrical communication with one or more resonant circuits 203 (e.g. LC tanks as shown) and one or multiple antennas (e.g., input antenna 101 and output antenna 103 that are optimized to passively receive and emit Radiofrequency (RF) signals over extended distances. In operation, a reader device can interrogate the SubHT 200 with a continuous-wave RF signal at a predefined frequency, denoted as fᵢₙ. As a consequence, a subharmonic RF signal is autonomously generated by the SubHT 200 at half of the input frequency, fᵢₙ/2.

When the acoustic transducer 300 receives an acoustic signal, it generates a corresponding low-frequency electrical signal (f_{ac}) across its terminals, which includes information from the acoustic signal. This low-frequency signal then interacts with the SubHT's 200 nonlinear dynamics to produce a spectrum of intermodulation products. These products are spaced from fᵢₙ/2 by (n×f_{ac}), where n signifies an intermodulation integer order. This process elevates the acoustic pressure information from the low frequencies of the acoustic domain to the higher frequencies of the EM domain, thereby making it possible to extract this information remotely via propagating electromagnetic waves. Thus, such sensors 100 not only enable the transmission of data over distances that far exceed those achievable with conventional acoustic detection schemes, but also paves the way for the deployment of scalable, short or long-distance, passive or semi-passive wireless sensing networks.

In some embodiments, the SubHT 200 is integrated with the input antenna 101 and the acoustic transducer 300 via a power combiner 105, configured to combine the input interrogation signal fᵢₙ and the low-frequency electrical signal f_{ac} for simultaneous and/or separate interaction with the SubHT 200. In some embodiments, where size, bandwidth, complexity, and cost permit, the sensor 100 can also include a matching network (not shown) for “boosting” signal power. As a whole or in part (e.g., including the input antenna 101, acoustic transducer 300, power combiner 105, SubHT 200, output antenna 103, matching network, subsets thereof, and/or combinations thereof) can be constructed as a monolithic integrated circuit, a hybrid circuit, a multi-chip module hybrid circuit, or combinations thereof.

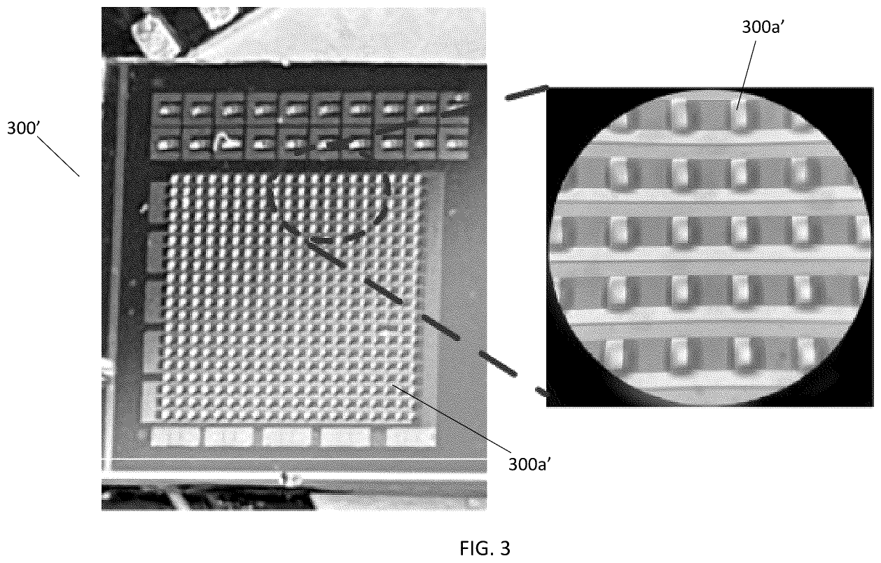

Referring now to FIGS. 1A, 1B, and 3, the acoustic transducer 300, 300′ can be any suitably compatible transducer having any number of transducer elements 300a, 300a′. For example, as shown in FIGS. 1A-1B, in some embodiments the acoustic transducer 300 can include a single transducer element 300a (e.g., a pMUT as shown) or, as shown in FIG. 3, the acoustic transducer 300′ can include a transducer array comprising a plurality of transducer elements 300a′ (e.g., a 20×20 pMUT array as shown). The acoustic transducer 300, 300′ and transducer elements 300a, 300a′ can be of any suitable type depending on the desired sensitivity and operational bandwidth including, for example, one or more piezoelectric micromachined ultrasonic transducer (pMUT) elements, one or more piezoelectric nanoscale ultrasonic transducer (pNUT) elements, one or more capacitive micromachined ultrasonic transducer (cMUT) elements, one or more bulk-piezo transducer elements, or combinations thereof. Such acoustic transducers 300, 300′ can generally be constructed from any suitable piezoelectric material including, for example, Polyvinylidene Fluoride (PVDF), Lead Zirconate Titanate (PZT), Zinc Oxide (ZnO), Aluminum Nitride (AlN) without doping, Lithium Niobate, other piezoelectric materials, or combinations thereof.

Referring still to FIG. 1B, to the extent that the acoustic transducer 300 or an acoustic transducer element 300a is a pMUT, the pMUT 300 can be represented using a modified Butterworth-Van Dyke (mBVD) equivalent circuit comprising an electrical branch 305 that accounts for the capacitance between two electrodes 307 309, which is connected in parallel with a motional branch 303. The motional branch 303 describes the plate dynamics and is represented by an RLC circuit as shown in FIG. 1B. The pMUT 300 also includes an input pressure receiver 301 for receiving the acoustic signal. FIG. 1B further illustrates the incorporation of the pMUT 300 with the SubHT's circuit 200. The SubHT circuit 200 is constructed using readily available passive components as described above and is intended to passively generate a subharmonic signal.

### Experimental Prototype

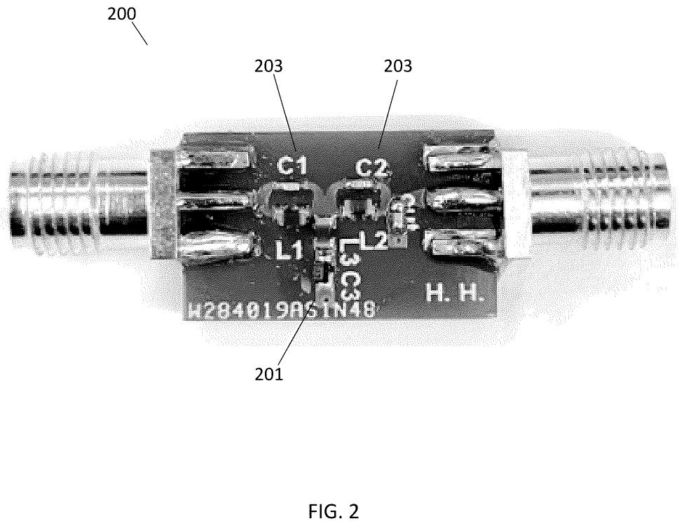

As shown in FIG. 3, the experimental prototype leverages the collective behavior of each pMUT transducer element 300a′ of an acoustic transducer 300′ comprising a 20×20 Sc₀₃₆Al_{0.64}N pMUT array operating at 550 kHz, which was paired with time-modulated solid-state components forming a SubHT 200 (FIG. 2), in order to facilitate the detection of acoustic waves over long distances without requiring an active power source. That is, to enable long-range passive sensing of acoustic waves. Thus, this framework notably enhances the receptive capabilities of the pMUTs 300a′ by transmuting each pMUT's inherent electrical signal, at f_{pMUT}, into radiofrequency (RF) subharmonic frequencies, a process intricately governed by the dynamics and nonlinearity of the SubHTs 200. As a result, the emitted subharmonic signal conveys the acoustic pressure detected by the pMUT 300a′, encoded within the amplitude of the subharmonic intermodulation. Empirical findings suggest that this RF subharmonic signal can be passively disseminated over extended distances, obviating the need for external power sources like batteries or active electronic circuits. This advancement sets the stage for groundbreaking, far-reaching pMUT-based passive wireless sensing networks (WSNs), expanding the operational horizons and application breadth of such sensing systems. The potential applications for the proposed device are broad and varied, encompassing fields such as structural health monitoring [11], underwater communication [12], among others. FIG. 2 illustrates a spectrum of innovative applications envisioned for the device.

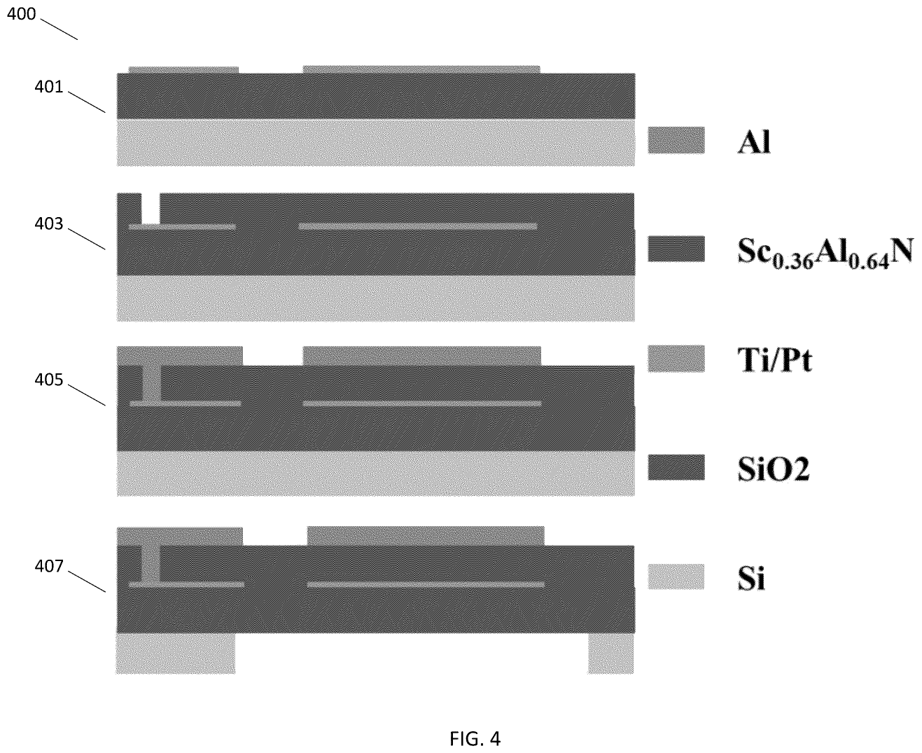

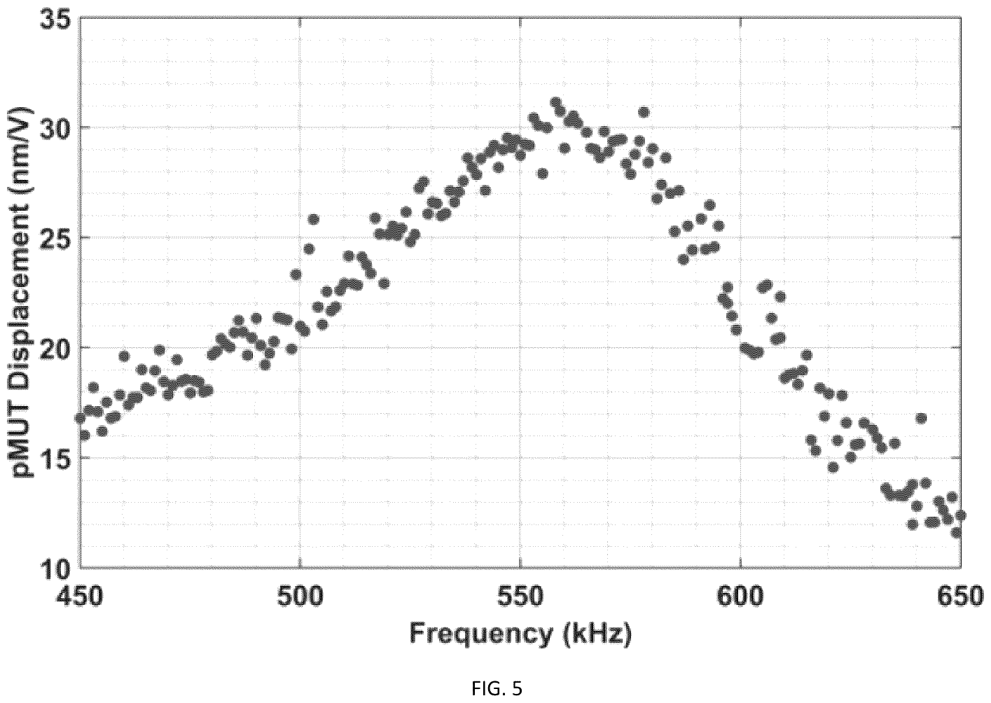

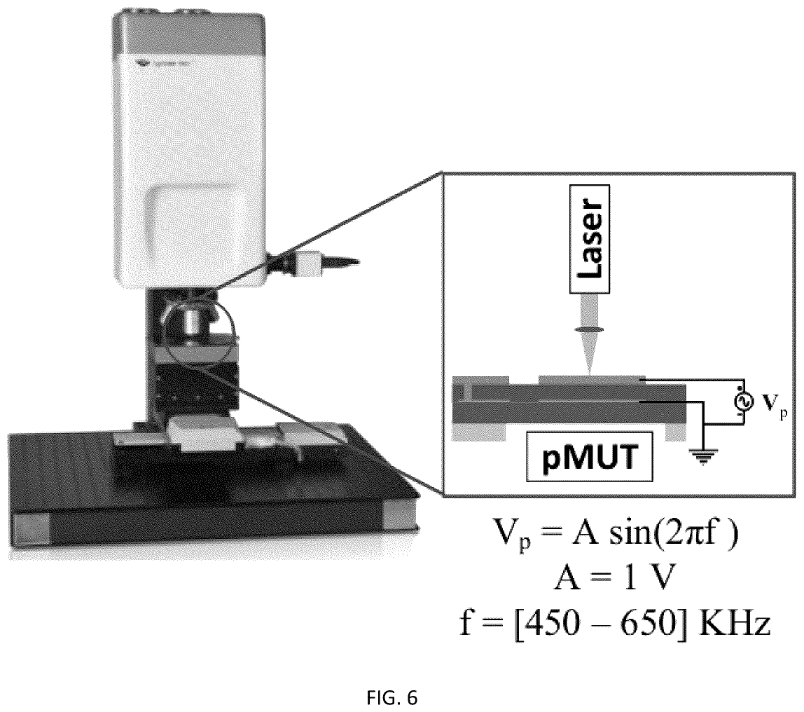

Referring now to FIG. 4, a method 400 for fabricating the experimental pMUTs 300a′ commenced with the utilization of a 300 μm thick, <100> orientation, double-side polished 4-inch silicon wafer. In step 401, a layer of silicon dioxide (SiO₂) with a thickness of 1 μm was grown on the wafer through a thermal process and a total of 140 nm of platinum (Pt) was subsequently deposited onto a titanium (Ti) adhesion layer with a thickness of approximately 5 nm. In step 403 the piezoelectric material Sc₀₃₆Al_{0.64}N was deposited using a co-sputtering technique, with a target thickness of 500 nm. The desired concentration was attained by applying 900 W DC power and 100 W RF power to the Aluminum (Al) target, while 710 W DC power was applied to the Scandium (Sc) target. This procedure closely resembled the one utilized in previous studies and [15]. The top electrodes were fabricated at step 405 by depositing and patterning 100 nm of aluminum using the lift-off technique. Finally, at step 407, a back-cavity was created by employing deep reactive ion etching (DRIE) on the backside of the wafer. The displacement sensitivity of the fabricated pMUTs is depicted in FIG. 5. As shown in FIG. 6, the displacement sensitivity depicted in FIG. 5 was measured using digital holographic microscopy.

It should be noted that, although this experimental demonstration employed a ScAlN-based ultrasonic transducer, specifically an array of pMUTs, the system's design is, as noted above, versatile and not limited to this specific type of transducer. It is adaptable to various transducers regardless of the medium through which their acoustic waves propagate, their operational frequency range, size, mechanism of operation, or the material they are made of. The key requirement is that the transducer, functioning as a sensor, must be capable of generating a current within its operating frequency range. This flexibility makes the system highly adaptable for a wide range of applications and environments.

### Experimental Methodology

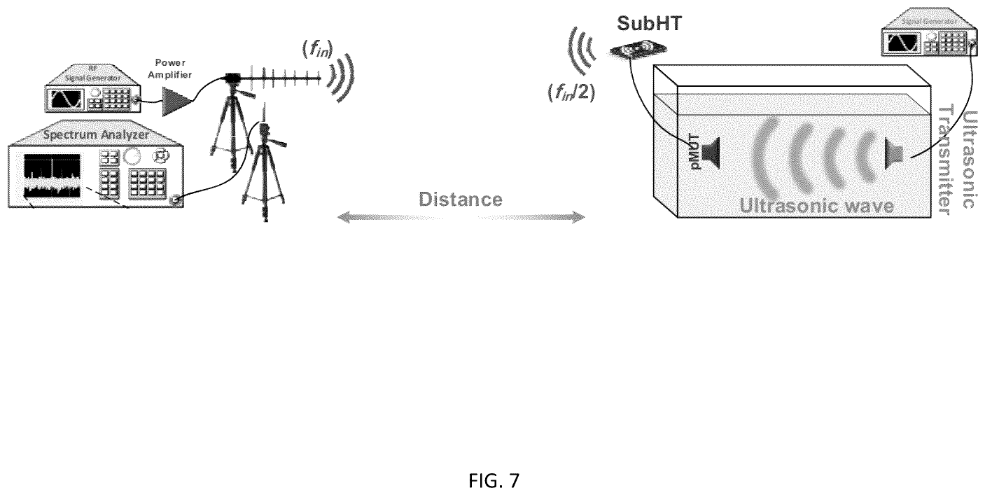

As shown in FIG. 7, the experimental setup included the pMUT-array 300′ connected to a SubHT 200, designed for sensing underwater acoustic pressure from a broadband transmitting ultrasound source. The SubHT 200 circuit employed off-the-shelf passive components and was tailored to passively generate a subharmonic signal at 435 MHz when wirelessly activated at 870 MHz. In the depicted experimental setup, the SubHT was wirelessly probed using a −9 dBm RF signal at 870 MHz from a transmitter situated approximately 3 meters away. This setup varied the peak-to-peak voltage (Vₚₚ) of the input signal applied to the transducer, enabling the observation of the tag's responses to different acoustic pressure levels.

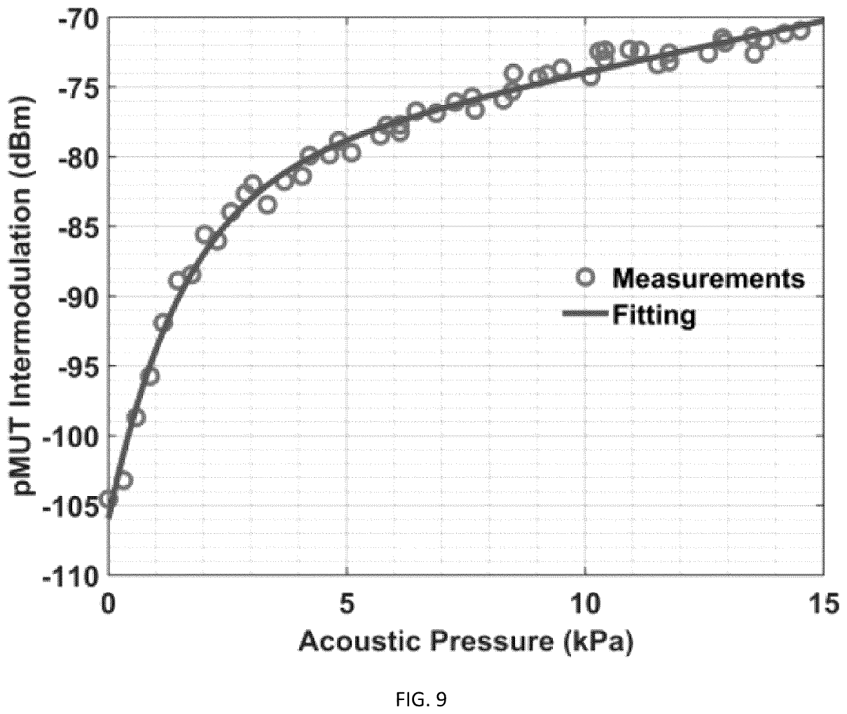

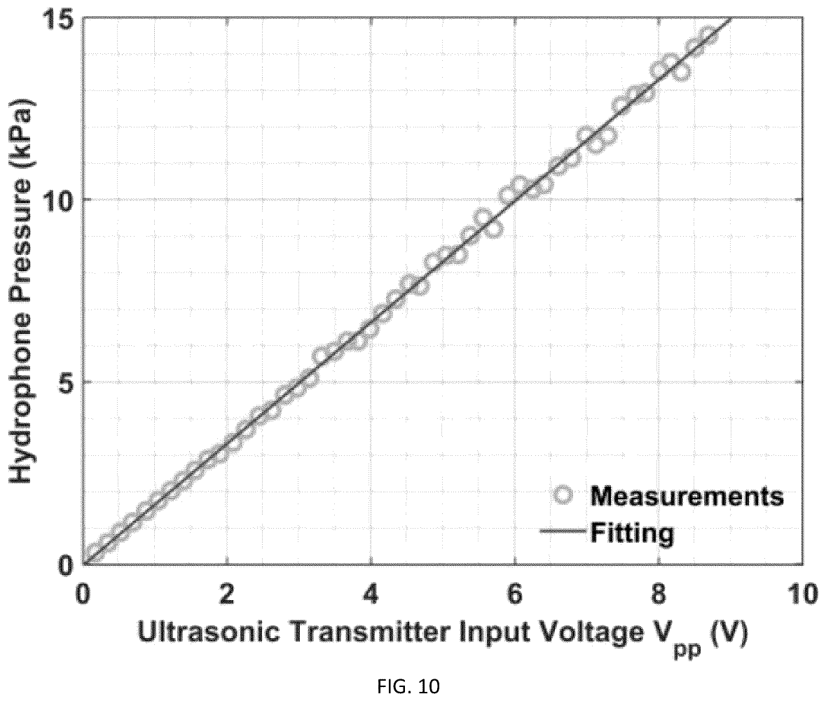

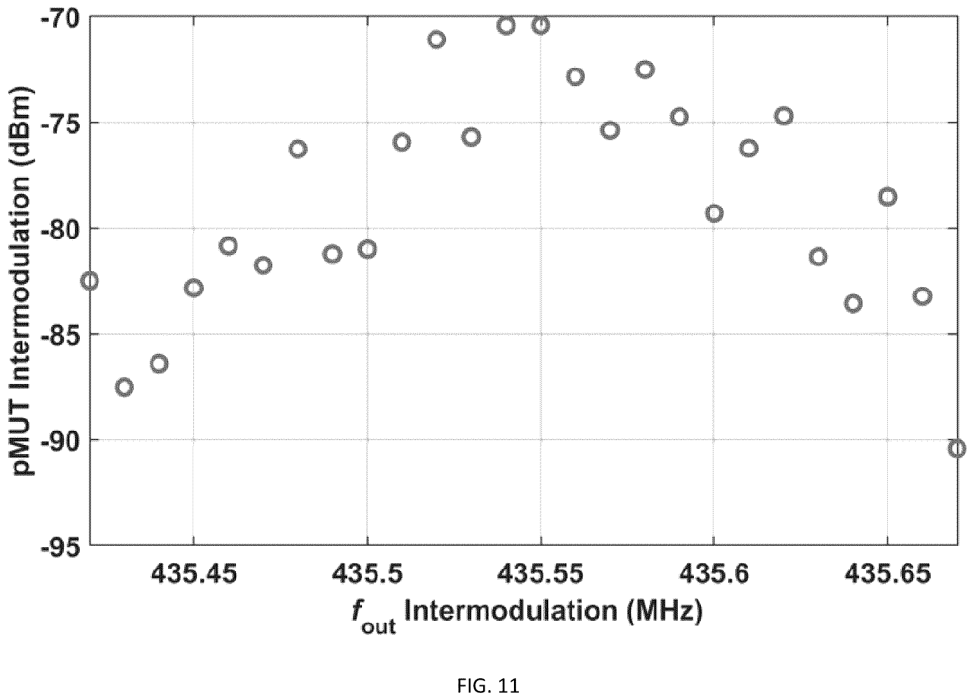

As shown in FIG. 9, measurements reveal a direct relationship between the amplitude of the pMUT intermodulation and the acoustic pressure, as detected at the pMUTs location with a hydrophone. As shown in FIG. 10, the acoustic pressure at the pMUT, as measured by the hydrophone generally correlated linearly to the ultrasonic transmitter's input voltage. Furthermore, the output power trajectory of the pMUT intermodulation signal shown in FIG. 11 correlates tightly with the documented pMUT displacement sensitivity shown in FIG. 5.

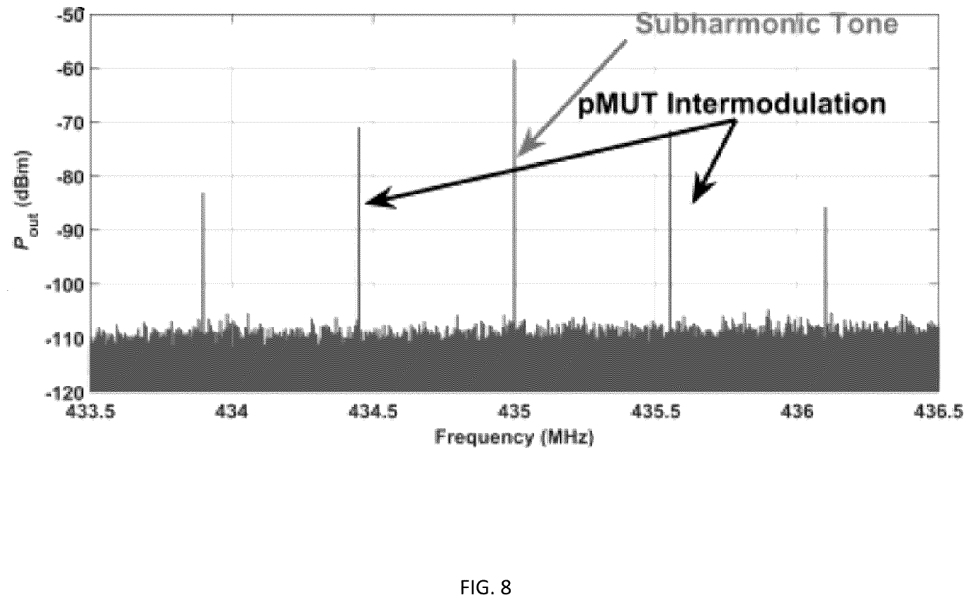

During testing, the SubHTs [13] leveraged the ScAlN pMUT-array, paired with distinct lumped-components such as a varactor and two antennas, to enable passive long-range RF signal transmission. This operation began by sending a continuous-wave RF signal at a chosen frequency (fᵢₙ) to the SubHTs. In response, the system autonomously produced a subharmonic RF signal at half of the initial frequency (fᵢₙ/2). Upon receipt of ultrasound waves by the pMUT-array, there emerged a distinct low-frequency electrical signal (f_{pMUT}) at its terminals. As shown in FIG. 8, this generated signal, when interacting with the SubHTs nonlinear dynamics, created intermodulation products which deviate from (fᵢₙ/2) by increments of (n·f_{pMUT}), where n symbolizes the intermodulation integer order. Thereby, the present technology facilitates the upconversion of acoustic pressure readings from kHz ranges to several hundreds of MHz. This strategy allows for the retrieval of acoustic pressure specifics through electromagnetic waves over distances that far exceed what conventional ultrasonic detection techniques offer.

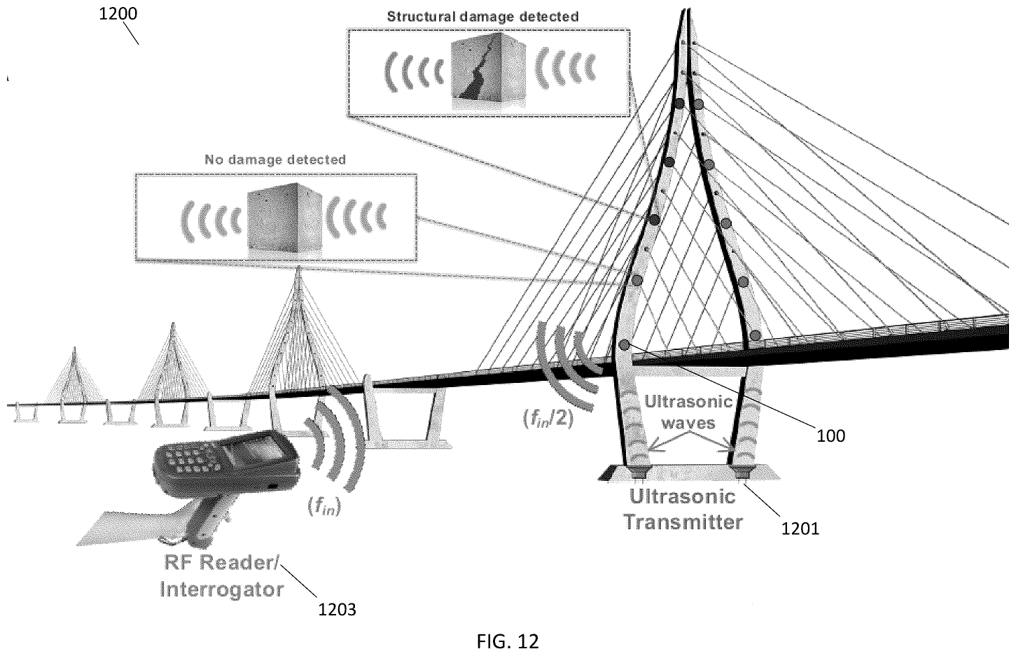

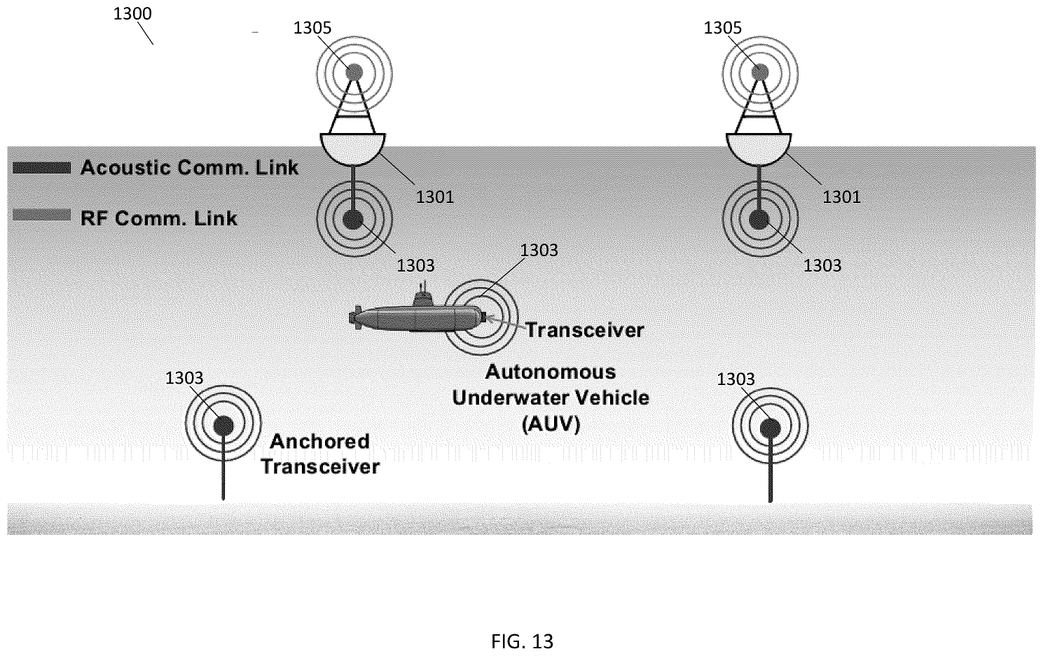

These advantages, in combination with the transducer-type flexibility discussed above makes the system highly adaptable for a wide range of applications and environments. Such applications and advantages include, for example, miniaturization of acoustic Wireless Sensor Networks (WSNs), reduced production and maintenance costs, the ability to be manufactured on a large scale, a reduced environmental footprint, owing to the elimination of batteries, sensors for ultrasound-based non-destructive testing techniques (NDT) for structural health monitoring systems (e.g., as shown in FIG. 12), underwater communication networking (e.g., as shown in FIG. 13), intrabody communications for medical or veterinary health monitoring, passive acoustic monitoring systems, eavesdropping for surveillance purposes, in air communication, localization of antennas, ultrasound-linked IoT nodes and passive acoustic monitoring components, wake-up receivers, and infrastructure monitoring (e.g., as shown in FIG. 12).

For example, the use of large-scale deployments of WSNs incorporating pMUTs is anticipated to play a critical role in the monitoring of essential environmental and structural parameters. In that regard, as shown in FIG. 12, in some embodiments, a system 1200 for monitoring the health of a structure (e.g., a bridge) via ultrasonic non-destructive testing is provided. As shown, in such a system, ultrasonic transmitters 1201 can be provided (e.g., at a bottom of the structure as shown) for transmitting ultrasonic waves through the structure. The system also includes a plurality of acoustic sensor tags 100 positioned in various locations on the monitored structure to receive the ultrasonic waves. The system 1200 also includes a radiofrequency reader 1203 for interrogating the sensor tags 100 to retrieve information about the ultrasonic waves. In some embodiments, the radiofrequency reader 1203 is configured to analyze information about the ultrasonic waves to detect and, in some instances, map any structural damage.

In some embodiments, the acoustic sensor tags can be deployed within a communication system 1300 straddling a fluid-air interface as shown in FIG. 13. Such fluid-air interfaces can occur in sea-to-air communications as shown in FIG. 13 but also in other contexts including ultrasonic devices implantable in a human or animal body. As shown in FIG. 13, the acoustic sensor tags provided herein can be useful as zero-power passive wake-up receivers in a communication system 1300, particularly near the fluid-air interface (e.g., at buoys 1301) so that active, powered RF transceivers 1305 and acoustic transceivers 1303 can be fully turned off when not being used, thereby greatly extending the service life of the on-board power source (e.g., batteries or power harvesting circuits).

As noted previously, conventionally, these WSNs rely on batteries that must be periodically replaced, thereby requiring regular maintenance that is often hard to implement. The present technology obviates these challenges via the implementation of battery-free, UHF, pMUT-based subharmonic tags (SubHTs) optimized for distant field sensing. Using the pMUT array operating, for example, at a resonant frequency of 550 kHz, the experimental prototype effectively converts the low-frequency vibrations of pMUTs into amplitude-modulated electrical signals. These signals are then concentrated around half of the subharmonic transducers' radiofrequency (RF) interrogation frequency. The present disclosure demonstrates a successful reading of the acoustic pressure by the pMUT array from approximately 16 meters away in an unregulated electromagnetic setting, thereby eradicating the need for batteries in acoustic WSNs.

In such fluid-to-air applications involving the implantation of ultrasonic devices into a human or animal body, one or more of the battery-free acoustic sensors provided herein can be implanted into a body to facilitate health monitoring and communication between the body and one or more external devices. In some embodiments, this can include one or more reader devices as discussed above. As in all embodiments, described herein, in some embodiments the reader device can further transmit received information to a central server, computer, or cloud system for further processing. Advantageously, use of such battery-free acoustic sensors in intrabody medical and veterinary applications can reduce the number of surgeries a patient must endure because the passive tag is not life-limited by battery life. Furthermore, such passive sensors eliminate the risk of potentially toxic battery materials leaking into the patient.

Novel features of the present technology include that the acoustic sensors provided herein enables passive or semi-passive, long-range acoustic sensing, minimizing or eliminating the need for a power source such as a battery or an energy harvester, while converting incident acoustic and RF signals into an acoustically modulated, RF re-transmitted signal. The acoustic sensor tags can be produced using readily available electronic components, enabling the sensor tags to be mass-manufactured with existing production lines. Additionally, the design of the acoustic sensor tags provides a flexible and versatile architecture with high adaptability, showing no sensitivity to the specific type of acoustic transducer. This versatility broadens applicability across many applications, as discussed above. The present technology also advantageously provides a new frequency upconversion communication paradigm for enhanced signal transmission, which translates into the unique ability to convert low-frequency acoustic signals to high-frequency radio waves in a manner that is applicable in various data transmission scenarios as described above. Additionally, the present technology also provides for identification and localization via tuning of the acoustic sensor tag's frequency of resonance, thereby allowing for global and local monitoring.

The present technology includes numerous advantages over previous technology, including, for example, reduced production and maintenance costs (since it shifts the cost onto wireless infrastructure, miniaturization of acoustic WSN, reduced production and maintenance costs, the ability to be manufactured on a large scale, a reduced environmental footprint, owing to the elimination of batteries, the present technology, by being the first passive acoustic sensor tag, paves the way for pMUT-based passive wireless sensing networks (WSNs), facilitating the use of such sensing systems in new areas of effectiveness and operational scope across a wide spectrum of pMUT-driven applications.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

### REFERENCES

[1] Jung, Y. H., Hong, S. K., Wang, H. S., Han, J. H., Pham, T. X., Park, H., . . . & Lee, K. J. (2020). Flexible piezoelectric acoustic sensors and machine learning for speech processing. Advanced Materials, 32(35), 1904020.
[2] Lang, C., Fang, J., Shao, H., Ding, X., & Lin, T. (2016). High-sensitivity acoustic sensors from nanofibre webs. Nature communications, 7(1), 11108.
[3] La, T. G., & Le, L. H. (2022). Flexible and wearable ultrasound device for medical applications: A review on materials, structural designs, and current challenges. Advanced Materials Technologies, 7(3), 2100798.
[4] Hassani, S., & Dackermann, U. (2023). A Systematic Review of Advanced Sensor Technologies for Non-Destructive Testing and Structural Health Monitoring. Sensors, 23(4), 2204.
[5] Gijsenbergh, P., Halbach, A., Jeong, Y., Torri, G. B., Billen, M., Demi, L., . . . & Rochus, V. (2019). Characterization of polymer-based piezoelectric micromachined ultrasound transducers for short-range gesture recognition applications. Journal of Micromechanics and Microengineering, 29(7), 074001.
[6] Roy, K., Lee, J. E. Y., & Lee, C. (2023). Thin-film PMUTs: a review of over 40 years of research. Microsystems & Nanoengineering, 9(1), 95.
[7] He, Y., Wan, H., Jiang, X. and Peng, C., 2022. Piezoelectric Micromachined Ultrasound Transducer Technology: Recent Advances and Applications. Biosensors, 13(1), p.55.
[8] Caro, M. A., Zhang, S., Riekkinen, T., Ylilammi, M., Moram, M. A., Lopez-Acevedo, O., Molarius, J. and Laurila, T., 2015. Piezoelectric coefficients and spontaneous polarization of ScAlN. Journal of Physics: Condensed Matter, 27(24), p.245901.
[9] Olsson, R. H., Tang, Z. and D'Agati, M., 2020 March. Doping of aluminum nitride and the impact on thin film piezoelectric and ferroelectric device performance. In 2020 IEEE Custom Integrated Circuits Conference (CICC) (pp. 1-6). IEEE.
[10] Giribaldi, G., Soukup, B. H., Simeoni, P., Colombo, L. and Rinaldi, M., 2022 January. Matching network-boosted 36% scaln pmut linear array. In 2022 IEEE 35th International Conference on Micro Electro Mechanical Systems Conference (MEMS) (pp. 251-254). IEEE.
[11] Xu, T., Zhao, L., Li, Z., Yuan, J., Zhao, Y., Luo, G., Li, J., Li, Z., Yang, P. and Jiang, Z., 2021 January. A PMUT-Based Ultrasonic Probe Used for Contact Force Sensing. In 2021 IEEE 34th International Conference on Micro Electro Mechanical Systems (MEMS) (pp. 419-422). IEEE.
[12] Herrera, B., Pop, F., Cassella, C. and Rinaldi, M., 2020. Miniaturized PMUT-based receiver for underwater acoustic networking. Journal of Microelectromechanical Systems, 29(5), pp.832-838.
[13] Hussein, H. M., Rinaldi, M., Onabajo, M. and Cassella, C., 2021. A chip-less and battery-less subharmonic tag for wireless sensing with parametrically enhanced sensitivity and dynamic range. Scientific reports, 11(1), p.3782.
[14] Pirro, M., Herrera, B., Assylbekova, M., Giribaldi, G., Colombo, L. and Rinaldi, M., 2021 January. Characterization of dielectric and piezoelectric properties of ferroelectric alscn thin films. In 2021 IEEE 34th International Conference on Micro Electro Mechanical Systems (MEMS) (pp. 646-649). IEEE.
[15] Herrera. B., Pop. F., Cassella. C. and Rinaldi, M., 2019. January. Frequency Agile PMUT-Based Ultrasonic Communication Links. In 2019 IEEE 32nd International Conference on Micro Electro Mechanical Systems (MEMS) (pp. 974-977). IEEE.

What is claimed is:

1. A wireless, battery-free acoustic sensor, comprising:
a subharmonic tag (SubHT); and
an acoustic transducer;
wherein the acoustic transducer is integrated with the SubHT, such that an acoustic signal received by the acoustic transducer modulates an electrical output of the SubHT when the SubHT is interrogated by a radiofrequency input signal of a reader device, resulting in conversion of the acoustic signal into information transmitted by the sensor via a radiofrequency output signal without the use of battery power.

2. The sensor of claim 1, wherein the acoustic transducer is capable of receiving an acoustic signal and transmitting an electromagnetic signal comprising information from the acoustic signal.

3. The sensor of claim 2, wherein:
the acoustic signal has a frequency in an audible range of 20 Hz to 20 kHz; and
the acoustic transducer is a piezoelectric microphone.

4. The sensor of claim 2, wherein:
the acoustic signal is an ultrasonic signal having a frequency greater than 20 kHz; and
the acoustic transducer includes at least one piezoelectric micromachined ultrasonic transducer (pMUT) element, at least one piezoelectric nanoscale ultrasonic transducer (pNUT) element, at least one capacitive micromachined ultrasonic transducer (cMUT) element, at least one bulk-piezo transducer element, or combinations thereof.

5. The sensor of claim 4, wherein the acoustic transducer includes an array of pMUT elements, pNUT elements, cMUT elements, or combinations thereof.

6. The sensor of claim 1, wherein the output signal is an amplitude modulated radiofrequency signal.

7. The sensor of claim 1, further comprising a radiofrequency input antenna integrated with the SubHT and configured to receive the input signal from the reader device.

8. The sensor of claim 2, wherein an input antenna for receiving the input signal from the reader device and the acoustic transducer are integrated with the SubHT via a power combiner configured to combine the electromagnetic input from the acoustic transducer with the input signal from the input antenna, and to transmit a combined signal to the SubHT.

9. The sensor of claim 3, further comprising a second acoustic transducer, wherein:
the acoustic signal is an ultrasonic signal; and
the second acoustic transducer includes at least one piezoelectric micromachined ultrasonic transducer (pMUT) element and/or at least one capacitive micromachined ultrasonic transducer (cMUT) element.

10. The sensor of claim 1, wherein the acoustic transducer is monolithically integrated with the SubHT.

11. The sensor of claim 1, wherein the acoustic transducer is hybridly integrated with the SubHT.

12. The sensor of claim 1, wherein a frequency of the output signal is half of a frequency of the input signal.

13. The sensor of claim 1, wherein the frequency of the input signal is an overtone of a fundamental resonant frequency of the SubHT.

14. The sensor of claim 2, wherein:
a frequency of the output signal is half of a frequency of the input signal;
a frequency of the electromagnetic signal transmitted by the acoustic transducer is lower than the frequency of the output signal; and
the electromagnetic signal transmitted by the acoustic transducer interacts with the SubHT to produce a spectrum of intermodulation products, each spaced from the frequency of the output signal according to the product of multiplying the frequency of the electromagnetic signal transmitted by the acoustic transducer by a corresponding intermodulation integer order.

15. An acoustic sensing system comprising:
one or more wireless, battery-free acoustic sensors, each sensor including a subharmonic tag (SubHT) and an acoustic transducer; and
a reader device configured for transmitting a radiofrequency input signal to the one or more acoustic sensors,
wherein the acoustic transducer of each sensor is integrated with the SubHT of that sensor such that an acoustic signal received by the acoustic transducer modulates an electrical output of the SubHT when the SubHT is interrogated by the radiofrequency input signal of the reader device, resulting in conversion of the acoustic signal into information transmitted by the sensor via a radiofrequency output signal without the use of battery power, and
wherein the reader device is further configured for receiving the radiofrequency output signal transmitted in return by the one or more acoustic sensors.

16. The system of claim 15, further comprising one or more acoustic transceivers and/or transmitters capable of transmitting the acoustic signal to the sensor.

17. The system of claim 15, wherein the reader is further configured to extract the acoustic signal received by the sensor, or information associated therewith, from the modulated radiofrequency output signal received by the reader device.

18. A method of monitoring acoustic signals in an environment, the method comprising the steps of:
providing the system of claim 16, wherein one or more sensors of the system are deployed in said environment;
transmitting the radiofrequency input signal to a sensor of the system using the reader device; and
receiving the radiofrequency output signal from the sensor using the reader device;
whereby the radiofrequency output signal received by the reader device is modulated by an acoustic signal received by the sensor from the environment.

19. The method of claim 18, further comprising:
extracting the acoustic signal received by the sensor, or information associated therewith, from the modulated electromagnetic signal received by the reader device.

20. The method of claim 18, wherein a distance between the sensor and the reader device is at least 10 meters.

21. The method of claim 20, wherein the distance between the sensor and the reader device is at least 1000 meters.

22. The method of claim 18, wherein the radiofrequency input signal is received either contemporaneously with the acoustic signal or non-contemporaneously with the acoustic signal.
